(19) United States
(12) Patent Application Publication
(10) Pub. No.: US 2006/0008009 A1
(43) Pub. Date: Jan. 12, 2006

(54) Method and system for entropy coding for scalable video codec

(75) Inventors: Yiliang Bao, Irving, TX (US); Marta Karczewicz, Irving, TX (US); Justin Ridge, Irving, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/887,771

(22) Filed: Jul. 9, 2004

(51) Int. Cl. H04B 1/66; H04N 11/02; H04N 11/04; H04N 7/12

(52) U.S. Cl. 375/240.24; 375/240.08; 375/240.23

(57) ABSTRACT

A method, program product and apparatus for encoding a scalable bit stream from the binarization results of a video sequence by selectively encoding syntax elements and avoiding redundancy in coding. The result is a decrease in the size of the compressed bit stream of an enhancement layer. One method includes determining whether a skipping flag in the base layer macro block of the video data is set, and encoding an enhancement layer macro block of the video data, corresponding to the base layer macro block, with a skipping flag only if the base layer macro block skipping flag is set. Another method includes determining which of a plurality of blocks in a base layer macro block contain zero coefficients, generating a coded block pattern (CBP) of an enhancement layer macro block, where the CBP includes a number of digits equal to the number of blocks in said base layer macro block containing only zero coefficients, and then encoding the CBP of the enhancement layer. Yet another method includes encoding a CBP value of a base layer macro block and differentially encoding a CBP value of an enhancement layer macro block relative to the CBP of the base layer macro block. An additional method includes determining the zero-value coefficients in a block of a base layer, determining whether any of the zero-coefficients become non-zero coefficients in a corresponding block in an enhancement layer, and encoding a coding block flag in an enhancement layer based on that determination.

### BACKGROUND OF THE INVENTION

A. Field of the Invention

The present invention is directed to the field of video coding and, more specifically, to scalable video coding.

B. Background

Conventional video coding standards (e.g. MPEG-1, H.261/263/264) involve encoding a video sequence according to a particular bit rate target. Once encoded, the standards do not provide a mechanism for transmitting or decoding the video sequence at a different bit rate setting to the one used for encoding. Consequently, when a lower bit rate version is required, computational effort must be devoted to (at least partially) decoding and re-encoding the video sequence.

In contrast, with scalable video coding, the video sequence is encoded in a manner such that an encoded sequence characterized by a lower bit rate can be produced simply through manipulation of the bit stream; in particular through selective removal of bits from the bit stream.

In U.S. patent application Ser. No. 10/797,467, one system was proposed to efficiently convert a video sequence to a binary representation that describes a video sequence progressively in quality, while the correlation within a frame or among frames is efficiently exploited. Other conversion schemes to produce binarization results of video sequences are also available.

The present invention focuses on the strategies used in encoding such binarization results into a final bit stream. Particularly it focuses on encoding the binarization results using context-based adaptive binary arithmetic coding. An even more specific scalable video codec is developed based on H.264 with a Context-based Adaptive Binary Arithmetic Coding (CABAC) engine (ITU-T Recommendation, H.264, “Advanced video coding for generic audiovisual services”, pre-published, May 30, 2003, also known as Advanced Video Coding (AVC), or MPEG-4 part-10).

### SUMMARY OF THE INVENTION

This invention decreases the size of the compressed bit stream of the enhancement layer. In this invention, the term “enhancement layer” refers to data that improves the visual quality of previously encoded video data. When used with efficient predictive binarization algorithms, this invention generates a bit stream that has very competitive performance by avoiding encoding any redundant information. For some video sequences, it has been demonstrated that the compression efficiency equals that of a single layer, i.e. non-scalable, video stream.

A particular design based on the H.264 CABAC entropy coding engine is also proposed. By its design, the CABAC entropy coding engine is not suitable for scalable video coding. This invention extends it in a manner such that it is suitable for scalable video coding. Thus, in addition to providing very good coding performance, the present invention requires only minor changes to H.264. The invention re-uses most coding contexts that have already been defined in H.264. The entire CABAC core arithmetic coder is not modified at all.

The present invention is directed to a method, program product and apparatus for encoding a scalable bit stream from the binarization results of a video sequence by selectively encoding syntax elements, and avoiding coding of redundant information. The result is a decrease in the size of the compressed bit stream of an enhancement layer.

One exemplary embodiment of the invention includes determining whether a skipping flag in the base layer macro block of video data is set, and encoding the macro block skipping flag of an enhancement layer macro block of the video data, corresponding to the base layer macro block, only if the base layer macro block is set to a particular value.

Another exemplary embodiment of the invention includes determining which of a plurality of blocks in a base layer macro block contain zero coefficients, generating a coded block pattern (CBP) of an enhancement layer macro block, where the CBP includes a number of digits equal to the number of blocks in said base layer macro block containing only zero coefficients, and then encoding the CBP of the enhancement layer.

Yet another exemplary embodiment of the invention includes encoding a CBP value of a base layer macro block and differentially encoding a CBP value of an enhancement layer macro block relative to the CBP of the base layer macro block.

A further exemplary embodiment of the invention includes determining the zero-value coefficients in a block of a base layer, determining whether any of the zero-coefficients become non-zero coefficients in a corresponding block in an enhancement layer, and encoding a coding block flag in an enhancement layer based on that determination.

Other features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The foregoing advantages and features of the invention will become apparent upon reference to the following detailed description and the accompanying drawings, of which:

FIG. 1 illustrates a communications device employing the present invention;

FIG. 2 is a flow chart illustrating a method of a first exemplary embodiment of the invention; and

FIG. 3 illustrates a video encoder employing the present invention.

### DETAILED DESCRIPTION OF EXEMPLARY EMBODIMENTS

Existing binarization algorithms, such as that presented in U.S. patent application Ser. No. 10/797,467, provide a very efficient description of the enhancement layer. There nonetheless remains strong correlation between the enhancement layer description and the previous base layer description.

An entropy coding scheme similar to that in the non-scalable codec could always be used, but this would result in information being encoded repeatedly, resulting in very poor coding performance. This invention efficiently encodes the binarization results by selectively encoding the syntax elements using the correlation established in the binarization scheme.

A context-based adaptive binary arithmetic coding engine comprises two parts, context modeling and an arithmetic coding engine. The binary arithmetic coding engine usually encodes a symbol based on the current probability estimate of the symbol. The probability of a symbol is estimated in certain context in order to achieve good compression ratio. The context modeling in a compression system is to define various coding contexts in order to achieve the best possible compression performance.

In H.264, certain contexts and arithmetic coding engine have been defined to encode the syntax elements and coefficients into a non-scalable compressed bit stream. This invention addresses the issue of how to generate a scalable bit stream based on the binarization results generated by algorithms such as those described in U.S. patent application Ser. No. 10/797,467, reusing most coding contexts already defined in H.264, and defining new contexts when there are clear advantages of doing so. Another appealing feature of this invention is that it is not necessary to modify the basic arithmetic coding engine in H.264.

The entropy coding scheme of the present invention is an efficient engine to encode into a scalable bit stream the data generated by a binarization scheme such as, for example, that of U.S. patent application Ser. No. 10/797,467 entitled “Method and System for Scalable Binarization of Video Data”, filed on Mar. 9, 2004, the entire contents of which are incorporated herein by reference. Those skilled in the art will understand that other binarization schemes are available and that the present invention can be used with them.

Here the entropy encoding scheme based on H.264 is described, although the applicability of the present invention is not limited to H.264 based scalable video coding schemes. Similar extensions to other standards are possible when similar binarization algorithms are used.

In the discussion below, a “base layer” could mean the absolute base layer, possibly generated by a non-scalable codec such as H.264, or it could mean a previously-encoded enhancement layer that is used as the basis in encoding the current enhancement layer. The term “coefficient” below refers to either a quantized coefficient value, or to bits produced using a binarization scheme that progressively describes the coefficient with greater precision.

General Encoding Hierarchy in H.264

H.264 encodes the coefficients in the hierarchy described blow.

1. A frame of video data is partitioned into macro blocks (MB). An MB consists of a 16×16 luminance values, a 8×8 chrominance-Cb values, and a 8×8 chrominance-Cr values. An MB skipping flag is set in this level if all the information of this macro block can be inferred from the information that is already encoded, by using pre-defined rules.

2. If the macro block is not skipped, a Coded Block Pattern (CBP) is sent to indicate the distribution of the non-zero coefficients in the macro block. Further explanation regarding CBP appears below.

3. After a CBP is encoded, a coded block flag is sent in the next level for either 4×4 blocks or 2×2 blocks (depending on the coefficient type) to indicate whether there are any non-zero coefficients in the block.

4. If there are any non-zero coefficients in a block of size 4×4, or of size 2×2 for chroma DC coefficients, the coefficients are scanned in a predefined scanning order. The positions, as well as the values, of non-zero coefficients are encoded.

Next is described how these syntax elements are encoded in a scalable video coding (SVC) enhancement layer in accordance with the present invention.

Encoding of MB Skipping Flag

An MB can be skipped, i.e. not encoded, if the mode and motion vectors can be inferred from the information already encoded, and no nonzero coefficients are to be encoded. Whether or not an MB is to be skipped is indicated by the MB skipping flag.

In the present invention, an MB skipping flag is encoded in the enhancement layer only if the corresponding MB in the base layer is determined to have no non-zero coefficients. One way this determination is made is by checking whether a MB skipping flag in the base layer indicates that the MB in the base layer is skipped, e.g. the base layer MB skipping flag has a value of 1.

Conversely, when the MB skipping flag of a MB in the base layer indicates that the MB is not skipped, e.g. the MB skipping flag has a value of 0, the corresponding MB in the enhancement layer is not skipped and no MB skipping flag is encoded.

A skipping flag in enhancement layer is encoded in the context of skipping flags of the neighboring MBs at enhancement layer. The same coding contexts defined in H.264 are used.

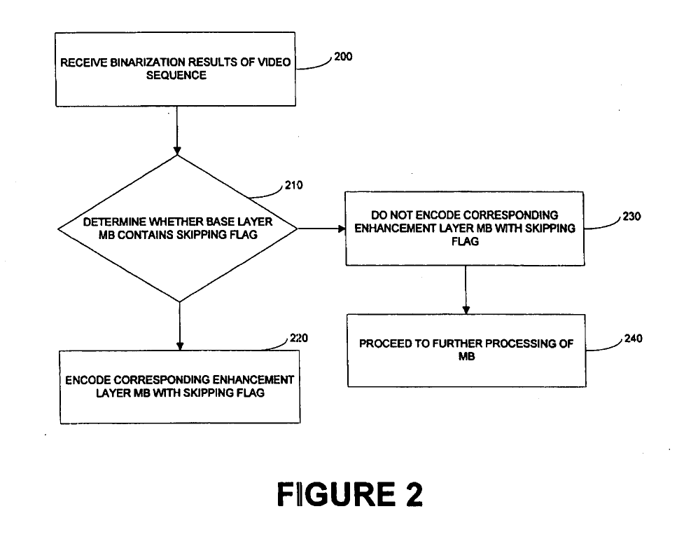

FIG. 2 is a flow chart illustrating this aspect of the invention. In block 200, the binarization results of a video sequence are received. In block 210, it is determined whether a given base layer MB contains a skipping flag, or more generally, whether it contains no no-zero coefficients. If so, then in block 220, the corresponding enhancement layer MB is encoded with a skipping flag and the method repeats with the next MB. If not, then in block 230, the corresponding enhancement layer MB is not encoded with a skipping flag and the method proceeds to block 240 with further processing of the given MB.

Encoding of MB Coded Block Pattern (CBP)

The MB coded block pattern has two parts, CBPY and CBPC. CBPY consists of four bits indicating which 8×8 luminance blocks among four 8×8 luminance blocks in an MB contain non-zero coefficients. CBPC is, in the preferred embodiment, a number in the range 0-2 that indicates the presence of non-zero chroma (either Cb or Cr) coefficients in the MB, in accordance with the scenarios described below. Other scenarios are of course possible and would result in different coded block patterns and possibly a different range of numbers. A “terminating value” for a CBPY or CBPC is the scenario that conveys the maximum amount of information about the coefficients in the MB that a scheme will allow. In the scenarios described below the terminating value for CBPC is 2.

1. A CBPC value of 0 indicates that there are no non-zero DC or AC coefficients in either chrominance block.

2. A CBPC value of 1 indicates that one or more DC coefficients are non-zero, and all AC coefficients are zero.

3. A CBPC value of 2 indicates that some AC coefficients are non-zero irrespective of DC values.

In the present invention, CBPY bits at an enhancement layer are encoded selectively. Bits are encoded only for those 8×8 luma blocks whose CPB bits are zero, i.e., they have no non-zero coefficients, in the base layer. When the corresponding 8×8 base layer luma block does contain non-zero coefficients, the 8×8 luma block in the enhancement layer is coded as though it had a CBP value of 1, but no CPB value is encoded.

The CBPY bits that are sent are encoded in the context of CBPY bits of the neighboring MBs. The same coding context definition as H.264 is used.

In the preferred embodiment, the number of bits so removed is equal to the number of 8×8 blocks within corresponding MBs at previous layers with non-zero coefficients, but this need not necessarily be the case.

CBPC in the enhancement layer is also defined dependent on a base layer.

1. If CBPC of an MB in the base layer is 0, the H.264 CBPC definition and coding context definitions are used for CBPC of this MB in the enhancement layer.

2. If CBPC of an MB in base layer is 1, since CBPC of the MB in the enhancement layer can only be either 1 or 2, it is only necessary to send one bit to indicate whether the CBPC of the MB in the enhancement layer is equal to 1 or not. The same context definition as in H.264 is used for this bit.

3. If CBPC of an MB in base layer is 2, CBPC of the MB in the enhancement layer is also 2, but in this scenario the CBPC value is not encoded.

Encoding of Coded Block Flag

There are five different types of blocks in the actual coefficient encoding. They are luma 4×4 AC block from intra4×4 prediction, luma 4×4 DC block from intra16×16 prediction, luma 4×4 AC block from intra16×16 prediction, chroma 4×4 AC block, and chroma 2×2 DC block. In H.264, a coded block flag is sent to indicate whether a block contains any nonzero coefficients. This flag can have values 0 or 1; a value of 0 indicates that there are no non-zero coefficients, while a value of 1 indicates that there is at least one non-zero coefficient in the block.

In this invention, the definition of coded block flag is extended for the enhancement layer. If the corresponding block in the base layer has no non-zero coefficients (i.e., if the corresponding coded block flag in the base layer is 0), the normal coded block flag definition is used. This is referred to as a type-1 coded block flag. For type-1 coded block flags, the same coding contexts defined in H.264 are used.

The case where a corresponding block in the base layer has some non-zero coefficients is further divided into two cases. When the corresponding block in the base layer contains at least one zero-value coefficient, a coded block flag referred to as a type-2 coded block flag is encoded. When the corresponding block in the base layer contains only non-zero coefficients, no coded block flag is encoded, as it is impossible for any coefficients to change from being zero in the base layer to non-zero in the enhancement layer.

If the type-2 coded block flag is 0, there are no new nonzero coefficients in the enhancement layer. If the flag is 1, this indicates that more coefficients have become nonzero.

Type-2 coded block flags have different statistics from the normal coded block flag. New contexts for encoding the type-2 coded flag are defined. The new contexts are defined based on the number of non-zero coefficients in the block in the base layer, the size of the block, and the conditions of the neighboring blocks.

Encoding of Coefficients

In H.264, a coefficient can only be zero or nonzero. In scalable video coding, a coefficient is successively refined. There are three cases regarding a coefficient's value in the enhancement layer.

1. The coefficient is zero both in the base and in the enhancement layer.

2. The coefficient is zero in the base layer, but non-zero in the enhancement layer. This case happens when the coefficient has been correctly predicted in the base layer, but not in the enhancement layer. For this case, a significance map determines the position of the coefficient. In addition, the sign of the coefficient needs to be sent.

3. The coefficient is nonzero in the base layer, and information is sent in the enhancement layer to make the coefficient more accurate. The additional information sent in the enhancement layer for this coefficient is called refinement information.

Encoding of Significant Coefficient Map and Size of New Significant Coefficients

In H.264, locations of nonzero coefficients are encoded using two flags, significant_coeff_flag and last_significant_coeff_flag. The flags are sent in the scanning order defined in H.264. A significant_coeff_flag of value 1 is sent for a nonzero coefficient at the current scanning position. A significant_coeff_flag of value 0 is sent for a zero coefficient at the current scanning position. Flag last_significant_coeff_flag is sent only if significant_coeff_flag is 1. The value of last_significant_coeff_flag is 0, if there are more nonzero coefficients following the current coefficient in the scanning order. Otherwise the last significant_coeff_flag is 1.

In the present invention, significant_coeff_flag in the enhancement layer is sent only for the coefficients that are zero in the base layer. The same coding contexts defined in H.264 could be used.

In the present invention, last_significant_coeff_flag is defined similarly as in the base layer. The same coding contexts defined in H.264 could be used. New contexts could also be formed based on the number of non-zero coefficients in the base layer, and the block size.

If a coded block flag is zero, irrespective of whether it is type-1 or type-2, encoding of the significance coefficient map is not necessary.

Encoding of Coefficient Refinement Information

Coefficient refinement information is generated in the enhancement layer for the coefficients that are non-zero in the base layer. A refinement bit indicates how to refine a coefficient to a higher fidelity.

In the binarization scheme presented in the afore-mentioned U.S. patent application Ser. No. 10/797,467, the encoder could choose not to send any refinement bits at all if the encoder determines that the coefficient is of comparatively high accuracy. The encoder could also choose to send more than 1 refinement bits to refine a coefficient that is of comparatively low accuracy.

There is no corresponding part in H.264 for the coefficient refinement bits. New coding contexts are defined. The contexts are defined based on the position of the predicted value with respect to the interval in the binarization scheme used to provide the input. The contexts could also be defined considering the size of the interval.

The invention can be implemented directly in software using any common programming language, e.g. C/C++ or assembly language. This invention can also be implemented in hardware and used in consumer devices.

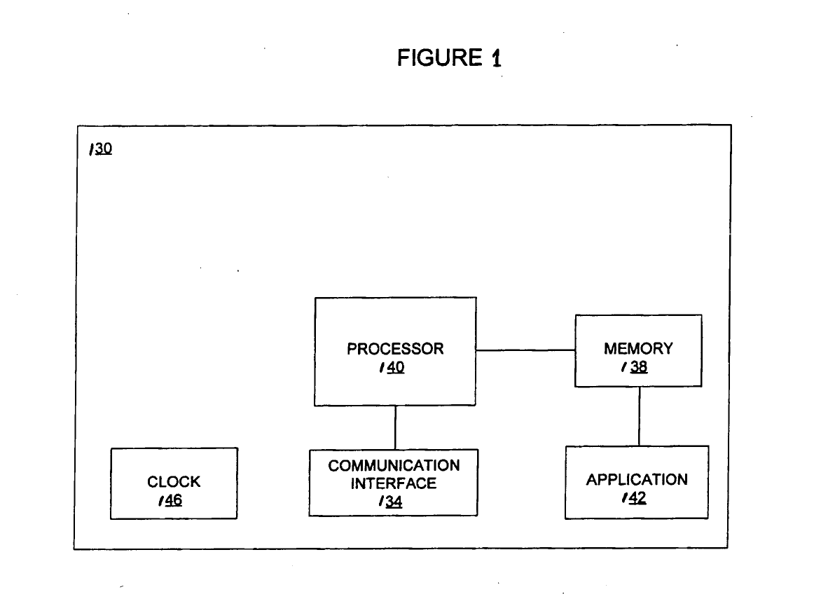

One possible implementation of the present invention is as part of a communication device (such as a mobile communication device like a cellular telephone, or a network device like a base station, router, repeater, etc.). A communication device 130, as shown in FIG. 1, comprises a communication interface 134, a memory 138, a processor 140, an application 142, and a clock 146. The exact architecture of communication device 130 is not important. Different and additional components of communication device 130 may be incorporated into the communication device 130. For example, if the device 130 is a cellular telephone it may also include a display screen, and one or more input interfaces such as a keyboard, a touch screen and a camera. The scalable video encoding techniques of the present invention would be performed in the processor 140 and memory 138 of the communication device 130.

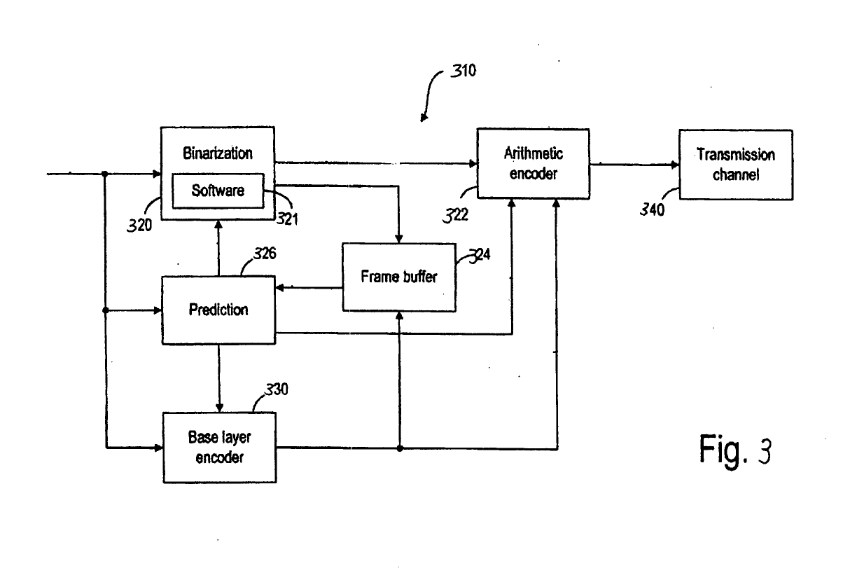

FIG. 3 illustrates a video encoder 310 that uses a coefficient binarization process and encodes a scalable bit stream in accordance with the present invention. As shown, the video encoder 310 comprises a binarization block 320 to emit binary bits to an arithmetic coding block 322. The binarization block 320 receives original signals indicative of the original value of the coefficients and provides reconstructed values of the coefficients to a frame buffer block 324. Based on signals indicative of emitted binary bits provided by the binarization block 320 and motion information from the prediction block 326, the arithmetic coding block 322 submits encoded video data in a bitstream to a transmission channel 340. It is understood that the binarization procedure can be carried out by hardware or software in the binarization block 320. For example, the binarization block 320 may contain a software program 321 for carrying out binarization steps. Furthermore, the video encoder 310 may comprise a base layer encoder 330, operatively connected to the prediction block 326, the frame buffer block 324 and the arithmetic coding block 322, to carry out base layer encoding providing a signal indicative of base layer encoded data. The base layer encoder 330 as such is known in the art.

The present invention can also be implemented in a decoder is a manner very similar to an encoder. Most of the inputs needed under the present invention are available to both encoders and decoders of a given bit stream.

As noted above, embodiments within the scope of the present invention include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

The invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein and in the claims is intended to encompass implementations using one or more lines of software code, and/or hardware implementations, and/or equipment for receiving manual inputs.

The foregoing description of embodiments of the present invention has been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principals of the present invention and its practical application to enable one skilled in the art to utilize the present invention in various embodiments and with various modifications as are suited to the particular use contemplated.

What is claimed is:

1. A method of encoding a scalable bit stream comprising binarized video data, said method comprising:
determining whether a base layer macro block of said video data contains no non-zero coefficients; and
encoding a skipping flag for an enhancement layer macro block of said video data, corresponding to said base layer macro block, only if it is determined that said base layer macro block contains no non-zero coefficients.

2. A method of encoding a scalable bit stream according to claim 1, wherein the determination of whether said base layer macro block contains no non-zero coefficients is made by checking whether a skipping flag in said base layer macro block contains one of a predetermined set of values.

3. A method of encoding a scalable bit stream according to claim 1, further comprising encoding said enhancement layer macro block without a skipping flag if it is determined that said base layer macro block contains at least one non-zero coefficient.

4. A method of encoding a scalable bit stream according to claim 2, wherein said skipping flag in the enhancement layer macro block is encoded using the same context as that of neighboring enhancement layer macro blocks.

5. A method of encoding a scalable bit stream according to claim 2, wherein an arithmetic coder is used to encode said skipping flag in said enhancement layer macro block.

6. A method of encoding a scalable bit stream according to claim 5, wherein said arithmetic coder is context based and context selection is based on macro block skipping flag values from neighboring enhancement layer macro blocks.

7. A method of encoding a scalable bit stream comprising binarized video data, said method comprising:
determining which of a plurality of blocks in a base layer macro block contain zero valued coefficients;
generating a coded block pattern (CBP) of an enhancement layer macro block, said CBP comprising a number of digits equal to the number of blocks in said base layer macro block containing only zero valued coefficients; and
encoding the CBP of the enhancement layer.

8. A method of encoding a scalable bit stream comprising binarized video data, according to claim 7, wherein said determination is made by analyzing a CPB of said base layer macro block.

9. A method of encoding a scalable bit stream according to claim 7, wherein an arithmetic coder is used to encode the CBP.

10. A method of encoding a scalable bit stream according to claim 9, wherein said arithmetic coder is context based and context selection is based on CBP values from macro block neighboring the enhancement layer macro block.

11. A method of encoding a scalable bit stream comprising binarized video data, said method comprising:
encoding a coded block pattern (CBP) value of a base layer macro block; and
differentially encoding a coded block pattern (CBP) value of an enhancement layer macro block relative to said coded block pattern of said base layer macro block.

12. A method of encoding a scalable bit stream according to claim 11, wherein an arithmetic coder is used to encode the CBP values.

13. A method of encoding a scalable bit stream according to claim 12, wherein said arithmetic coder is context based and context selection is based on CBP values from macro block neighboring the enhancement layer macro block.

14. A method of encoding a scalable bit stream according to claim 11, wherein a CBP value is not transmitted in the enhancement layer macro block if the CBP value of the base layer has attained a terminating value.

15. A method of encoding a scalable bit stream comprising binarized video data, said method comprising:
determining the zero-value coefficients in a block of a base layer; and
encoding a coded block flag for a corresponding block of an enhancement layer only when said determination indicates that said block in said base layer contains only zero-value coefficients.

16. A method of encoding a scalable bit stream according to claim 15, wherein the coded block flag for an enhancement layer block is only encoded when at least one coefficient from the corresponding base layer block is zero.

17. A method of encoding a scalable bit stream according to claim 16, wherein a determination is made as to whether any zero-value coefficients in a base layer block become non-zero coefficients in a corresponding enhancement layer block, and the coded block flag for said enhancement layer block is set to a value based on said determination.

18. A method of encoding a scalable bit stream comprising binarized video data, said method comprising:
determining, for each coefficient in a base layer block, whether said coefficient is zero; and
determining, for each coefficient in an enhancement layer block corresponding to said base layer block, whether said enhancement layer coefficient is zero; and
encoding a significance digit for each coefficient in said enhancement layer block, said digit indicating whether the results of said determinations differ.

19. A method of encoding a scalable bit stream according to claim 18, wherein coefficient information is only encoded when the significance digit is of a particular value.

20. A method of encoding a scalable bit stream according to claim 19, wherein an arithmetic coder is used to encode the significance digits.

21. A method of encoding a scalable bit stream according to claim 19, wherein a terminating digit is transmitted following each significance digit indicating a transition from a zero to non-zero coefficient, said terminating digit indicating whether any coefficients positioned later in the enhancement layer block according to some scan order transition from being zero to non-zero.

22. A method of encoding a scalable bit stream according to claim 21, wherein an arithmetic encoder is used to encode the terminating digits.

23. A method of encoding a scalable bit stream according to claim 22, wherein context selection is based at least in part on the number of non-zero coefficients in the base layer.

24. A method of encoding a scalable bit stream according to claim 22, wherein context selection is based at least in part on the size of the block being encoded.

25. A method of encoding a scalable bit stream according to claim 21, wherein context selection is based, at least in part, on both the number of non-zero coefficients in the base layer and on the size of the block being encoded.

26. A method of encoding a scalable bit stream comprising binarized video data, said method comprising:
generating zero or more refinement bits for each non-zero coefficients from a base layer block, according to some binarization method; and
encoding said refinement bits using an entropy coder.

27. A method of encoding a scalable bit stream according to claim 26, wherein an arithmetic coder is used to encode the refinement bits.

28. A method of encoding a scalable bit stream according to claim 27, wherein contexts are defined at least partly based on the position of a predicted value for the coefficient with respect to a bounding interval.

29. A method of encoding a scalable bit stream according to claim 27, wherein contexts are defined at least partly based on the size of a bounding interval surrounding the refined coefficient value.

30. A program product for encoding a scalable bit stream comprising binarized video data, said program product containing machine readable program code for causing, when executed, one or more machines to perform the following:
determining whether a base layer macro block of said video data contains no non-zero coefficients; and
encoding a skipping flag for an enhancement layer macro block of said video data, corresponding to said base layer macro block, only if it is determined that said base layer macro block contains no non-zero coefficients.

31. A program product for encoding a scalable bit stream according to claim 30, wherein the determination of whether said base layer macro block contains no non-zero coefficients is made by checking whether a skipping flag in said base layer macro block contains one of a predetermined set of values.

32. A program product for encoding a scalable bit stream according to claim 30, further comprising encoding said enhancement layer macro block without a skipping flag if it is determined that said base layer macro block contains at least one non-zero coefficient.

33. A program product for encoding a scalable bit stream according to claim 30, wherein said skipping flag in the enhancement layer macro block is encoded using the same context as that of neighboring enhancement layer macro blocks.

34. A program product for encoding a scalable bit stream according to claim 30, wherein an arithmetic coder is used to encode said skipping flag in said enhancement layer macro block.

35. A program product for encoding a scalable bit stream according to claim 34, wherein said arithmetic coder is context based and context selection is based on macro block skipping flag values from neighboring enhancement layer macro blocks.

36. A program product for encoding a scalable bit stream comprising binarized video data, said program product containing machine readable program code for causing, when executed, one or more machines to perform the following:
determining which of a plurality of blocks in a base layer macro block contain zero valued coefficients;
generating a coded block pattern (CBP) of an enhancement layer macro block, said CBP comprising a number of digits equal to the number of blocks in said base layer macro block containing only zero valued coefficients; and
encoding the CBP of the enhancement layer.

37. A program product for encoding a scalable bit stream comprising binarized video data, according to claim 36, wherein said determination is made by analyzing a CPB of said base layer macro block.

38. A program product for encoding a scalable bit stream according to claim 36, wherein an arithmetic coder is used to encode the CBPs.

39. A program product for encoding a scalable bit stream according to claim 38, wherein said arithmetic coder is context based and context selection is based on CBP values from macro block neighboring the enhancement layer macro block.

40. A program product for encoding a scalable bit stream comprising binarized video data, said program product containing machine readable program code for causing, when executed, one or more machines to perform the following:
encoding a coded block pattern (CBP) value of a base layer macro block; and
differentially encoding a coded block pattern (CBP) value of an enhancement layer macro block relative to said coded block pattern of said base layer macro block.

41. A program product for encoding a scalable bit stream according to claim 40, wherein an arithmetic coder is used to encode the CBP values.

42. A program product for encoding a scalable bit stream according to claim 41, wherein said arithmetic coder is context based and context selection is based on CBP values from macro block neighboring the enhancement layer macro block.

43. A program product for encoding a scalable bit stream according to claim 40, wherein a CBP value is not transmitted in the enhancement layer macro block if the CBP value of the base layer has attained a terminating value.

44. A program product for encoding a scalable bit stream comprising binarized video data, said program product containing machine readable program code for causing, when executed, one or more machines to perform the following:
determining the zero-valued coefficients in a block of a base layer; and
encoding a coded block flag for a corresponding block of an enhancement layer only when said determination indicates that said block in said base layer contains only zero-valued coefficients.

45. An apparatus for encoding a scalable bit stream comprising binarized video data, said apparatus comprising:
a processor for determining whether a base layer macro block of said video data contains no non-zero coefficients; and
an encoder for encoding a skipping flag for an enhancement layer macro block of said video data, corresponding to said base layer macro block, only if it is determined that said base layer macro block contains no non-zero coefficients.

46. An apparatus for encoding a scalable bit stream comprising binarized video data, said apparatus comprising:
a processor for determining which of a plurality of blocks in a base layer macro block contain zero valued coefficients;
a processor for generating a coded block pattern (CBP) of an enhancement layer macro block, said CBP comprising a number of digits equal to the number of blocks in said base layer macro block containing only zero valued coefficients; and
an encoder for encoding the CBP of the enhancement layer.

47. An apparatus for encoding a scalable bit stream comprising binarized video data, said apparatus comprising:
an encoder for encoding a coded block pattern (CBP) value of a base layer macro block; and
an encoder for differentially encoding a coded block pattern (CBP) value of an enhancement layer macro block relative to said coded block pattern of said base layer macro block.

48. An apparatus for encoding a scalable bit stream comprising binarized video data, said apparatus comprising:
a processor for determining the zero-value coefficients in a block of a base layer; and
encoding a coded block flag for a corresponding block of an enhancement layer only when said determination indicates that said block in said base layer contains only zero-value coefficients.

49. A communication device comprising:
a processor;
a memory connected to said processor;
a communication interface connected to said processor; and
an input interface connected to said processor for receiving video data;
wherein said processor is configured to encode a scalable bit stream comprising binarized video data by selectively encoding syntax elements to avoid redundancy and transmit said scalable bit stream through said communication interface.

50. An apparatus for decoding a scalable bit stream comprising encoded video data, said apparatus comprising:
a processor for determining whether a base layer macro block of said video data contains no non-zero coefficients; and
a decoder for decoding a skipping flag for an enhancement layer macro block of said video data, corresponding to said base layer macro block, only if it is determined that said base layer macro block contains no non-zero coefficients.

51. An apparatus for decoding a scalable bit stream comprising encoded video data, said apparatus comprising:
a processor for determining which of a plurality of blocks in a base layer macro block contain zero valued coefficients;
a processor for decoding a coded block pattern (CBP) of an enhancement layer macro block, said CBP comprising a number of digits equal to the number of blocks in said base layer macro block containing only zero valued coefficients.

52. An apparatus for decoding a scalable bit stream comprising encoded video data, said apparatus comprising:
a processor for decoding a coded block pattern (CBP) value of a base layer macro block; and
a processor for decoding a value corresponding to the differentially coded block pattern (DCBP) of an enhancement layer macro block corresponding to said base layer macro block; and
a processor for adding said differentially coded block pattern of said enhancement layer macro block to said coded block pattern of said base layer macro block for the purpose of determining the coded block pattern for said enhancement layer macro block.

53. An apparatus for decoding a scalable bit stream comprising encoded video data, said apparatus comprising:
a processor for determining the zero-value coefficients in a block of a base layer; and
a processor for decoding a coded block flag for a corresponding block of an enhancement layer only when said determination indicates that said block in said base layer contains only zero-value coefficients.
